(19) United States
(12) Patent Application Publication
(10) Pub. No.: US 2026/0357595 A1
(43) Pub. Date: Nov. 12, 2026

(54) VISUAL ASSISTANCE FOR THE CLADDING OF STRUCTURAL ELEMENTS

(71) Applicant: Weinmann Holzbausystemtechnik GmbH, St. Johann (DE)

(72) Inventors: Sebastian Czech, Stuttgart (DE); Mathias Wagner, Ditzingen (DE)

(73) Assignee: Weinmann Holzbausystemtechnik GmbH, St. Johann (DE)

(21) Appl. No.: 19/666,639

(22) Filed: May 4, 2026

(30) Foreign Application Priority Data
May 7, 2025 (DE) 102025117440.7

(51) Int. Cl. E04G 21/18

(52) U.S. Cl. CPC E04G 21/1841

(57) ABSTRACT

A pictogram may assist the cladding of structural elements, in particular, for buildings. The pictogram is placed on a panel, which is to be attached to a supporting structure of the structural element along with other panels. The pictogram illustrates the arrangement of the panel on the structural element and preferably relative to the other panels.

### CROSS-REFERENCE TO RELATED APPLICATIONS

This application claims priority to German Patent Application No. DE 10 2025 117 440.7, filed May 7, 2025, the entire contents of which are hereby incorporated in full by this reference.

### DESCRIPTION

### FIELD OF THE INVENTION

The invention relates to a method for producing a structural element by cladding a supporting structure with a plurality of panels, in particular, wood-based panels. The invention further relates to a structural element comprising a supporting structure clad with panels. Furthermore, the invention relates to a machine system for producing a structural element by cladding a supporting structure with a plurality of panels.

### BACKGROUND OF THE INVENTION

For example, structural elements, which are clad with panels, are used in the construction of houses. Such structural elements can be, in particular, wall elements, floor elements or ceiling elements. Often, a framework of a plurality of beams is covered on one side or, more commonly, on both sides with one or more panel layers to form the structural element.

The panels of a structural element typically differ from one another. In particular, the panels may have cutouts in various locations, for example for windows, doors, sockets or beams and/or chamfers. Rectangular panels of varying dimensions may also be provided. The panels must therefore be positioned correctly on the framework.

In practice, the panels are often placed manually onto the framework. To determine the correct position, staff can use a technical drawing or a construction plan. However, identifying a panel and its position on the structural element using such drawings is complex and prone to errors.

It is also known to mark panels with an identification number. Known identification numbers are used, for example, to manage the design data of the panels or the panels themselves, but do not allow assignment to the position of the panel on the structural element.

### SUMMARY OF THE INVENTION

Object of the invention: One object of the invention is to facilitate the correct arrangement of panels on a supporting structure of a structural element.

Description of the invention: This object is achieved according to the invention by a method according to claim 1, a pictogram according to claim 11, a panel according to claim 12, a structural element according to claim 13 and a machine system according to claim 14. The corresponding dependent claims specify advantageous variants or embodiments.

Cladding method according to the invention:
According to the invention, a method for producing a structural element is provided. The structural element is produced by cladding a supporting structure with a plurality of panels, in particular, wood-based panels. The structural element can be used to construct a building. The structural element can be, for example, a wall element, floor element or ceiling element.

The method can be carried out using a machine system according to the invention as described below.

First, the supporting structure and the plurality of panels are provided.

The supporting structure, which is to be covered with the panels, can have a plurality of beams, which can, in particular, form a framework. The supporting structure can be obtained in a manner known per se by connecting a plurality of beams. The supporting structure can consist entirely or partially of wooden and/or metal components. For example, sheet metal profiles can be used instead of or in addition to wooden beams.

The panels, or at least one of the panels, can be, for example, chipboard, in particular, multi-layer chipboard. The panels, or at least one of the panels, can be so-called OSB panels, with aligned strands, or softwood fiberboards. The panels, or at least one of the panels, can also be plasterboard panels or insulation panels.

The panels typically have a front side and a back side, which are usually aligned parallel to one another. The thickness of the panel can range from a few millimeters, e.g., at least 5 mm, to a plurality of centimeters, e.g., at most 20 cm. The largest longitudinal dimension of the panel can be at least 2 m, in particular, at least 3 m or at least 4 m. A transverse dimension of the panel can be at least 1 m, in particular, at least 2 m. In special cases, the transverse dimension can be between 0.1 m and 1 m.

According to the invention, each panel bears a pictogram that represents its corresponding position on the structural element. This makes it much easier to arrange the panels in the intended position. The pictogram may contain a schematic representation of the structural element. Advantageously, the pictogram allows the positioning of the corresponding panel at the intended location on the supporting structure without having to study documents such as technical drawings or construction plans. This makes manually placing the panels easier and faster. Furthermore, the pictogram helps to avoid errors. If the panels are placed automatically, the pictogram can be captured by a camera and processed by image analysis. This can simplify the programming of an automatic handling device for placing the panels.

The panels are placed on the supporting structure at the position shown in the pictogram. As explained above, the pictogram facilitates the correct positioning of the panels; the pictogram thus making this work simpler, faster and less prone to errors.

The panels are then fastened to the supporting structure, for example by nails, staples and/or screws. The fastening can be done manually and/or automatically. The panels can be provisionally attached to the supporting structure, in particular, manually. Final fastening can then take place automatically.

The method can be used to produce structural elements in a production facility (factory). The panels with the pictograms and the supporting structure can be manufactured and fastened to one another in the production facility. The structural element can then be installed in a building on a construction site.

It is also conceivable to produce at least one of the panels with its pictogram in a production facility, but to carry out the placement and fastening on a construction site (at the location of final use of the structural element).

The pictograms enable clear identification and assignment of the panels even outside the factory, e.g., during assembly on the construction site. On the construction site, the at least one panel, or the panels, can be easily identified by the pictogram and mounted in the correct position on the correct supporting structure. This reduces search and sorting efforts and minimizes assembly errors. The panel can be placed and fastened before the structural element is installed in a building. Alternatively, the panel can be placed and fastened after the supporting structure, to which one or more other panels may already be fastened, has been installed in the building.

Furthermore, it is conceivable to produce at least one of the panels on a construction site (at the location of final use of the structural element) and to place it on the supporting structure and fasten it to the supporting structure at the construction site. The pictogram can serve as a production order for producing the panel. The pictogram, in particular, in the form of a sticker, can be handed over to the construction site and used there as a production order. The panel can be cut out from a raw panel on the construction site and be provided with the pictogram. The panel is then placed on the supporting structure at the position shown in the pictogram and fastened to the supporting structure. The pictogram serves as a work instruction (job description) and for the unambiguous identification of the structural element or supporting structure for which the panel is intended. The panel can be placed and fastened before the structural element is installed in a building. Alternatively, the panel can be placed and fastened after the supporting structure, to which one or more other panels may already be fastened, has been installed in the building.

In all variants, the pictograms enable continuous traceability and identification of the panels from the factory or from production on the construction site to final assembly. It improves flexibility in the production process. Both centralized production steps (in the factory) and decentralized production steps (on the construction site) are supported. The pictograms can serve as an interface between work preparation, production and assembly. The use of pictograms enables error reduction and increased efficiency through clear assignment of the panels to the structural elements and visual assistance during placement and fastening.

The pictogram is typically attached on the front side of the panels, facing away from the supporting structure. In this case, the pictogram also indicates the orientation of the front and back of the panel, reducing another source of error. Furthermore, the pictogram on the front remains visible both when the product is placed on the surface and afterwards, which facilitates verification.

In special cases, the pictogram may be attached to the back of the panels facing the supporting structure. This may be required if the front side of the panels remains visible during use of the structural element.

The panels can be arranged on the structural element in one or more panel layers. A panel layer comprises the panels arranged side by side on one side of the supporting structure. On a first panel layer that is arranged immediately against the supporting structure, at least one further panel layer can be arranged, wherein the panels of the further panel layer are arranged on the panels of the panel layer that are further inwards (towards the supporting structure). The panels of different panel layers can consist of similar or different materials.

One or more panel layers can be arranged on two sides of the supporting structure facing away from one another.

The pictogram of at least one of the panels, preferably all panels, can represent not only the highlighted position of that panel but also the positions of other panels, in particular, all other panels in a panel layer of panels to be arranged side by side. Positioning the panel on the supporting structure is further facilitated, as the other panels serve as reference points to improve the overview.

Panels that have already been placed before the corresponding panel is placed may be marked differently than panels that are to be placed after the corresponding panel. Therefore, the pictogram shows which panels are already present on the supporting structure and which panels still need to be added after the current panel. This further improves the overview of the structural element. In particular, it simplifies placing the corresponding panel next to an existing panel.

The pictograms of the panels may contain a numbering corresponding to the sequence in which they are placed on the supporting structure. This makes it easier to select the panel that is to be placed. Furthermore, the specified sequence can simplify the placement of the panels on the supporting structure, for example next to other panels that have already been placed. For example, the placement can be done with consecutive numbers from right to left.

The panels can be provided in a transport apparatus, in particular, a panel trolley, which has a plurality of numbered compartments, with the panels being placed in the compartment corresponding to their number. Selecting the panel to be placed is then particularly easy by accessing the compartment with the next number.

The panels can be cut out from at least one raw panel. The sequence when placing them on the supporting structure may differ from a sequence when cutting them out and, in particular, from a sequence when sorting them into the transport apparatus. To minimize waste, the sequence in which the material is cut out often does not correspond to an expedient placement sequence. The numbering of the panels in the pictogram makes it easier to maintain this expedient placement sequence.

If a transport apparatus is used, the sorting into the transport apparatus typically takes place in the sequence in which the panels are cut out or dispensed by a sawing machine. In this case, the sequence in which the panels are placed may differ from the sequence in which they are sorted into the transport apparatus. Preferably, the panels are sorted into compartments according to the desired sequence of placing, the compartments generally not being directly adjacent for panels to be sorted immediately one after the other. In particular, the panels can be sorted into compartments numbered according to the sequence for placing. This allows preparation of the placement in the expedient sequence.

The pictogram of at least one of the panels, preferably all panels, can represent the structural element in a top view. The top view typically shows the side of the structural element with the panel. This is helpful to determine where the panel should be positioned on the surface of the structural element.

The pictogram of at least one of the panels, preferably of all panels, can represent the shape of the panel, and preferably the shapes of other panels, in particular, all other panels of a panel layer. By indicating the shape of the panel, its correct orientation is facilitated, for example at cutouts in the structural element or at other complexly shaped panels (with a non-rectangular surface).

Preferably, the pictogram depicts the shape of the panel in its current orientation. In particular, an upper edge in the pictogram points to the upper edge of the panel, a lower edge in the pictogram points to the lower edge of the panel, a right edge in the pictogram points to the right edge of the panel, and a left edge in the pictogram points to the left edge of the panel. This makes it easier to recognize and understand the pictogram when handling the panel.

The pictograms can each be attached in similar locations on the panels. For example, all pictograms can be positioned in the bottom left corner of the panels. This simplifies setting up the correct orientation of the panel on the structural element. In particular, considerations about which edge of the panel must be oriented where can be omitted if the position of the pictogram on the panel makes it clear how the panel is to be rotated in its plane in order to align it correctly with the supporting structure.

The pictogram of at least one of the panels, preferably all panels, may contain a part number of the panel. In case of damage to the panel, a replacement panel can be obtained using the part number without having to study technical documentation for the structural element.

The pictogram of at least one of the panels, preferably all panels, can contain information about a destination, in particular, about the structural element and/or a construction project. When cutting out the panels with a view to minimizing waste, panels for different destinations are sometimes cut out from the same raw panel. Specifying the destination simplifies the logistics of redistributing the panels. Even if a panel has been mistakenly sorted into the wrong transport apparatus, this can be identified and corrected based on the specified destination.

The pictogram of at least one of the panels, preferably all panels, can contain information about the panel layer of a plurality of overlapping panels on the structural element. This makes it easier to assign the panel to its corresponding layer in the case of multi-layered cladding (with a plurality of overlapping panel layers).

It is conceivable to integrate additional information in the pictogram, e.g., assembly instructions, information data (such as QR codes or barcodes) for digital building records and/or for the traceability of the panels.

In particular, the pictograms can be used within a digital construction process, e.g., for mobile recording of panels on a construction site.

The pictogram of at least one of the panels, preferably all panels, can represent the structural element in a side view or in a cross-sectional view through the panel. In this way, the panel layer in which the panel is to be placed and/or the side of the supporting structure on which the panel is to be placed can be clearly identified.

The pictogram of at least one of the panels, preferably all panels, can be affixed to the panel. An affixing step can easily be integrated into an existing system for cutting out the panels. The affixing can be done manually, for example immediately after the panel has been cut out or immediately after the panel has been ejected from a sawing machine. This reduces the risk of an incorrect pictogram being applied to a panel. Alternatively, the affixing can be automated. Mismatches can then be prevented with particular certainty.

The pictogram of at least one of the panels, preferably all panels, can be printed on the panel. No material is required for a sticker. A printed pictogram can be advantageous for recyclability by reducing the number of different materials present on the structural element. Printing is advantageously done automatically. Automated printing can prevent mismatches between pictogram and panel and ensure correct placement and orientation of the pictogram.

The pictogram of at least one of the panels, preferably all panels, can be applied to the panel after the panel has been cut out. In this case, a raw panel, from which the panel is cut out, does not need to be fed into a sawing machine in a defined orientation. Especially with large raw panels, applying the pictogram to the smaller panel afterwards can be easier to implement, in particular, if this is to be done manually.

The pictogram of at least one of the panels, preferably all panels, can be applied to a raw panel before the panel is cut out from the raw panel. Errors in the assignment of pictogram and panel are then excluded when automatically cutting out the panels; however, it must be ensured that the raw panel is correctly oriented during the cutting-out process. However, the latter can be ensured if the pictograms are applied automatically and the raw panel is handled automatically. This also applies if the pictogram is applied to the raw panel immediately before cutting it out in a sawing machine.

The pictogram of at least one of the panels, preferably all panels, can be applied in a cutting machine, for example a sawing machine or nesting machine, which cuts out the panel from a raw panel. This prevents mismatches between pictogram and panel. The orientation of the raw panel when fed to the sawing machine is irrelevant for the allocation, since application and cutting out take place with the same orientation of the raw panel. Applying the pictogram in the sawing machine is also advantageous in that no separate station is required for applying the pictogram. This can, in particular, keep processing times short and the space required for a production plant small. The pictogram can be applied before or after the cutting out, and in special cases, even during the cutting process.

Pictogram according to the invention:
The invention also relates to a pictogram for a panel of a structural element, in particular, for use in a method according to the invention described above. The pictogram represents the position of the panel on the structural element. The pictogram may contain further information as described above and/or be designed in the manner described above. The pictogram can be in the form of a sticker. Alternatively, the pictogram can be provided as a data set for printing on a panel. The pictogram makes it possible to carry out the method according to the invention. In particular, the pictogram makes it possible to realize the advantages of the method according to the invention in the production of structural elements. By providing pictograms according to the invention, an existing production process for structural elements can be optimized in terms of simplifying work and avoiding errors.

Panel according to the invention:
The invention further relates to a panel with a pictogram according to the invention, described above. The pictogram can be printed onto or affixed to the panel, in particular. The pictogram can represent the shape of the panel. Preferably, the pictogram depicts the shape of the panel in its current orientation. The pictogram may contain further information as described above and/or be designed in the manner described above.

Structural element according to the invention:
The invention further relates to a structural element comprising a supporting structure clad with panels. At least one of the panels bears a pictogram that represents the position of the panel on the structural element. Preferably, all panels bear a pictogram that represents the position of the corresponding panel on the structural element. Advantageously, the at least one pictogram is a pictogram according to the invention. The advantages of the production method according to the invention can be realized during the production of the structural element. For a large number of structural elements, this can result in a reduced proportion of structural elements with incorrectly positioned panels. The structural element can therefore improve the quality of a building produced with the structural element. A building with at least one structural element according to the invention also falls within the scope of the present invention.

Machine system according to the invention:
The invention further relates to a machine system for producing a structural element by cladding a supporting structure with a plurality of panels, in particular, wood-based panels. The machine system can be used to carry out the method according to the invention, as described above.

The machine system has the following features: a support apparatus for a supporting structure; a control device for generating pictograms, wherein the control device is configured to generate the pictograms in such a way that each pictogram represents a position of a panel on a supporting structure; an output device for outputting the pictograms; and a fastening apparatus for fastening the panels to the supporting structure, in particular, according to the positions shown in the pictograms.

The support apparatus supports the supporting structure during the cladding. In the simplest case, the support apparatus can be formed by a support surface, such as a floor. Preferably, the support apparatus includes structures for aligning and/or fixing the supporting structure. This prevents the supporting structure from slipping during the cladding process and can simplify the precise positioning of the panels.

The control device can generate the pictograms from provided production data for the structural element. The generated pictograms are preferably pictograms according to the invention as described above. As explained above, the position shown in the pictograms corresponds to a target position where the corresponding panel is to be placed on the supporting structure and fastened to the supporting structure. The control device can be configured to generate the pictograms as a data set.

The output device allows the generated pictograms to be displayed.

The output device may, for example, include a screen for displaying the pictograms. Preferably, the control device is configured to display the pictogram of each panel to be placed during the successive placement of the panels.

The output device may include a printer for printing the pictograms on paper or stickers. Alternatively or additionally, the printer can be configured to print the pictograms directly onto the panels.

Preferably, the output device is designed to apply the pictograms to the panels. For this purpose, printouts of the pictograms can be affixed to the panels and/or attached to the panels. The pictograms can alternatively or additionally be applied directly to the panels, for example printed immediately onto the panels, or laser-etched or engraved into the panels.

The fastening apparatus enables the panels to be fastened to the supporting structure, preferably automatically. The correct arrangement of the panels on the supporting structure, assisted by the pictograms, prevents errors during fastening. The fastening apparatus can be designed to insert fasteners such as nails, staples and/or screws. The fastening apparatus may include a magazine for a supply of fasteners.

The machine system may include a provisioning apparatus for the panels with the applied pictograms. The pictograms may have been applied manually or, preferably, by the output device. The provisioning apparatus can be a (stationary) storage facility or a transport apparatus, for example a panel trolley. The provisioning apparatus can have numbered compartments for the panels.

The machine system may include a placement aid apparatus for holding the panels during manual placement and/or for assisting the manual placement of the panels at the position shown in the pictograms on the supporting structure. The placement aid apparatus may include a holding device, in particular, a panel gripper, which can be attached to the panels. The placement aid apparatus may include an assistance device for at least partially distributing the weight of the corresponding panel. The placement aid apparatus facilitates the manual placement of, in particular, heavy and/or unwieldy panels.

The machine system can include a cutting machine for cutting the panels from at least one raw panel. The cutting machine can be, in particular, a sawing machine and/or a nesting machine. The nesting machine can be set up to determine a waste-minimizing arrangement of a plurality of the panels on one or more raw panels, and to cut out the panels accordingly. The output device can be located inside the cutting machine or on the cutting machine, in particular, at an inlet for raw panels or at an outlet for the cut panels.

Further features and advantages of the invention can be found in the description, the claims, and the drawings. Likewise, the aforementioned features and those which are to be explained below can each be used individually or as a plurality in expedient combinations of any kind. The embodiments shown and described are not to be understood as an exhaustive list, but, rather, have an exemplary character for the description of the invention.

### BRIEF DESCRIPTION OF THE DRAWINGS

The invention is shown in the drawings and is described on the basis of embodiments.

FIG. 1 shows a structural element according to the invention, on which a plurality of panels according to the invention with pictograms according to the invention is already attached, during the attachment of a further panel according to the invention with a pictogram according to the invention, in a schematic perspective view;

FIG. 2 shows the structural element of FIG. 1, after all panels have been attached, in a schematic perspective view;

FIG. 3 shows a schematic representation of the pictogram of a first panel of the structural element of FIG. 1;

FIG. 4 shows a schematic representation of the pictogram of a second panel of the structural element of FIG. 1;

FIG. 5 shows a schematic representation of another pictogram according to the invention for a panel according to the invention for a structural element according to the invention;

FIG. 6 shows a schematic flowchart of a method according to the invention for producing a structural element according to the invention;

FIG. 7 shows a schematic diagram of a front view of a transport apparatus with a plurality of numbered compartments for use in the method according to the invention;

FIG. 8 shows a schematic diagram of a machine system according to the invention when a method according to the invention is carried out;

FIG. 9 shows a variant of a method according to the invention, in which panels with pictograms are mounted on a supporting structure at a construction site before the supporting structure is installed in a building;

FIG. 10 shows a modification of the method of FIG. 9, wherein the panels are mounted on the supporting structure after it has been installed in a building.

### DETAILED DESCRIPTION OF THE PREFERRED EMBODIMENTS

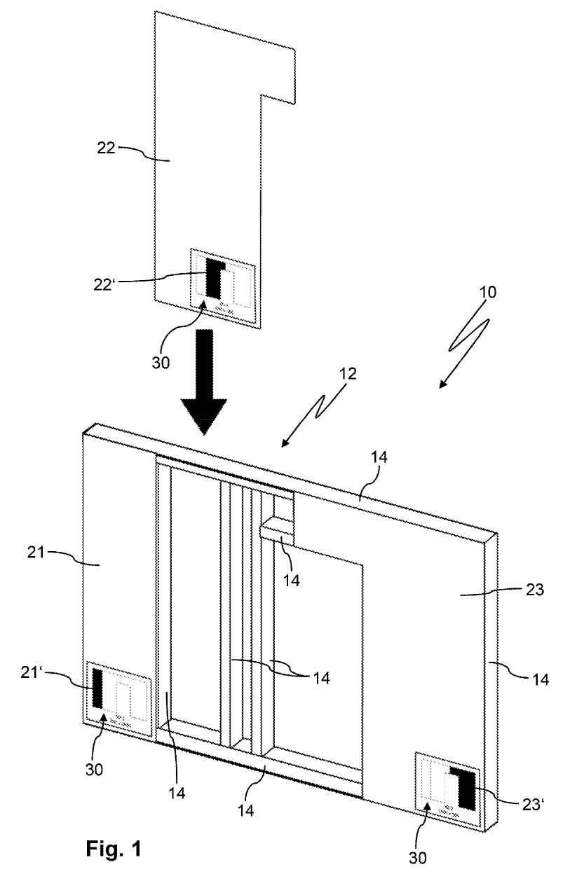

FIG. 1 shows a structural element 10 during its production. The structural element 10 has a supporting structure 12. The supporting structure 12 is formed with a plurality of beams 14, which are connected to one another to form a framework.

The supporting structure 12 will be clad with a plurality of panels 21, 22, 23 at least on a first side. For this purpose, the panels 21, 22, 23 are arranged (placed) on the supporting structure 12 and fastened to it. The panels 21-23 are made here of a wood-based material. The panels 21-23 have different shapes and sizes. The panel 21 is shown here as a rectangular shape by way of example. The panels 22 and 23 are shown here, for example, as an L-shape, although the short legs are oriented differently on the structural element 10. As an example, a door opening in the structural element 10 is formed between the panels 22 and 23. At least one of the panels 21-23 may have a cutout (not shown in detail) for an electrical installation, e.g., a light switch and/or a socket.

In the example of FIG. 1, the panels 21 and 23 are already arranged on the supporting structure 12. The panel 22 is to be placed on the supporting structure 12.

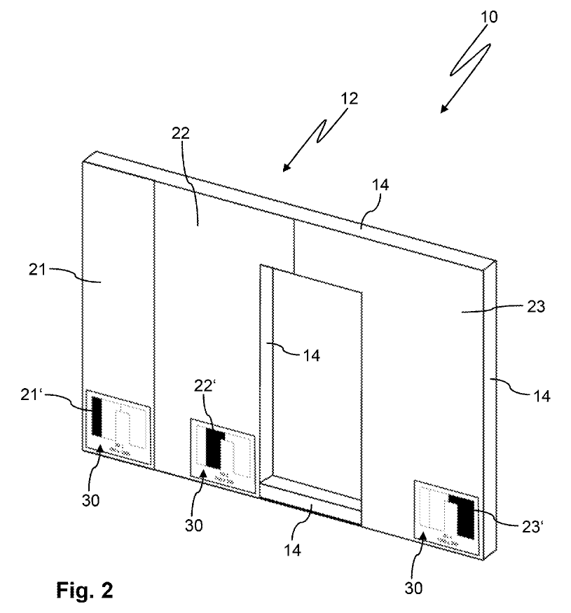

In FIG. 2, the finished structural element 10 is shown after the panel 22 has been arranged on and fastened to the supporting structure 12. It should be noted that, only as an example, the panel 22 is attached last to the supporting structure 12. The panels 21-23 could also be attached from left to right in the sequence 21-22-23 or vice versa from right to left in the sequence 23-22-21.

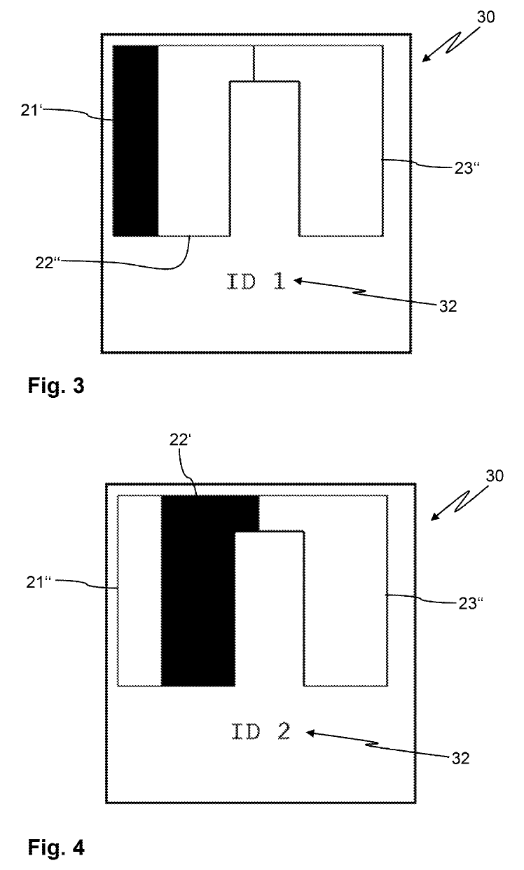

The panels 21-23 each bear a pictogram 30, which shows their corresponding position and orientation on the structural element 10, compare FIG. 3 for the pictogram 30 of the panel 21 and FIG. 4 for the pictogram 30 of the panel 22. The shapes of the panels 21-23 are also shown in the pictograms 30. For this purpose, the pictograms 30 each show a schematic top view of the side of the structural element 10 that is clad or is to be clad with the panels 21-23. The pictograms 30 are each attached on the side of the panels 21-23 facing away from the supporting structure 12.

The corresponding panel is highlighted in its pictogram 30, here exemplified by a full-surface representation of a sketch 21', 22', 23' of the corresponding panels 21, 22, 23. The corresponding panel could also be highlighted in color. The other panels are shown in the pictogram 30 by their outlines 21'', 22'', 23''. This illustrates the position of each panel 21-23 on the structural element 10 and relative to the other panels 21-23.

The pictograms 30 show the shapes of the panels 21-23 in the present (or in other words actual) orientation, compare FIG. 1 and 2. For example, if one of the panels 21-23 is oriented vertically, the panels are also shown vertically in the corresponding pictogram 30 and are correctly oriented upwards and downwards.

In the exemplary embodiment shown in FIG. 1 and 2, the pictograms 30 are each attached to similar locations on the panels 21-23. Here, the pictograms 30 are each placed in a lower right corner region of the panels 21‑23. On the panel 21, the pictogram 30 is so wide that it extends to the left edge. If a panel is too small at the intended location for attaching the pictogram (not shown in detail), the pictogram can be placed in a nearby location, for example on the right edge as low as possible. Preferably, however, the pictogram would be reduced in size so that it can be attached in the desired position.

In the exemplary embodiment shown in FIG. 3 and 4, the pictograms 30 each contain a part number 32 (“ID”) of the corresponding panel 21-23. The part number 32 corresponds here to the position of the corresponding panel 21-23 from left to right in the top view of the structural element 10.

For large structural elements, an additional row of panels could be provided. The panels could also interlock in the manner of a puzzle (not shown in detail).

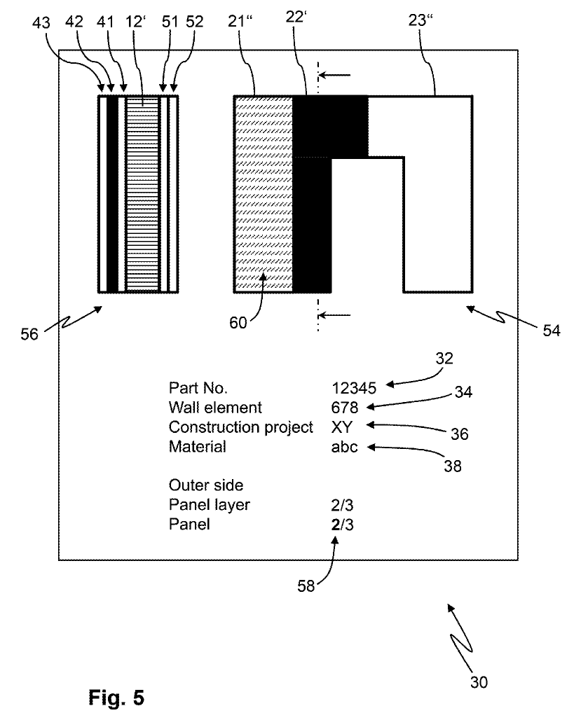

FIG. 5 shows another pictogram 30 for a panel 22 of a structural element 10 similar to that of FIG. 1 and 2. The pictogram 30 of FIG. 5 contains additional information and highlights compared to the pictogram of FIG. 4.

A part number 32 of the panel 22 is also shown here. In this case, however, the part number has no relation to the arrangement of the panel 22 on the structural element 10, but serves to identify the panel 22 and manage its design data.

In addition, information about the destination of the panel 22 is provided. In the example shown, this destination information includes a number 34 of the structural element 10, which here is a wall element. Furthermore, the construction project for which the structural element 10 is intended is specified, for example, by an address or, in this case, by a number 36.

Furthermore, material information, for example regarding the material which can be identified by an identifier 38, and/or a specification of the thickness of the panel 22 can be contained in the pictogram 30.

In the exemplary embodiment shown in FIG. 5, the supporting structure 12 is clad on both sides. Here, for example, three panel layers 41, 42, 43 stacked on top of one another are provided on an outer side and two panel layers 51, 52 stacked on top of each are provided on an inner side.

The pictogram 30 contains information about the side, in this case the outer side, for which the panel 22 is intended. This information is presented here in plain text.

In addition, besides the top view 54, the pictogram 30 shows a cross-sectional view 56 of the structural element 10. In the cross-sectional view 56, in addition to a representation 12' of the supporting structure, the inner and outer panel layers 41-43 and 51, 52 are shown.

Here, the panel 22 is determined for the second layer 42 of the outer side. This panel layer 42 is highlighted by way of example by full-surface and/or colored representation in the cross-sectional view 56, while the other panel layers 41, 43, 51, 52 are indicated by outlines. The information regarding the panel layer can also be provided in plain text.

Furthermore, the pictogram 30 of FIG. 5 contains information about the placement sequence of the panels within the relevant panel layer. Here, the panel 22 is to be placed as the second panel of three panels 21-23 in the second outer panel layer 42. This is, on the one hand, specified in plain text by a numbering system 58.

Furthermore, in the top view, a hatching pattern 60 indicates that when the panel 22 is placed, the panel 21 should already be placed. In the pictogram for the panel 23, the outlines 21'' and 22'' would accordingly be filled with a hatching pattern 60 (not shown in detail).

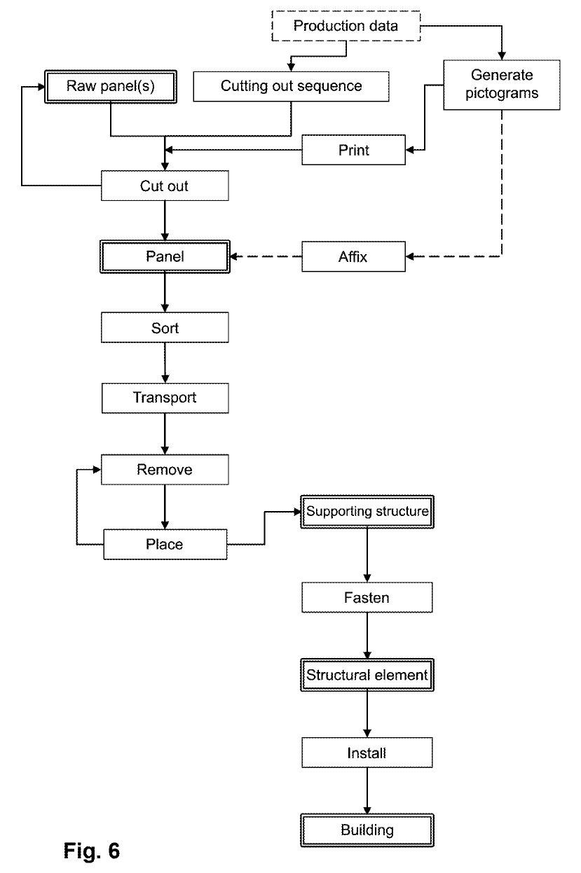

FIG. 6 shows a flowchart for the production of the structural element 10 using panels 21-23 with previously explained pictograms 30.

First, production data for the structural element 10 and the panels 21‑23 required for it are provided. The production data may contain, in particular, design data, such as technical drawings and material specifications, especially in the form of CAD data.

The pictograms 30 for the panels 21-23 are generated from the production data. The pictograms can first be created as an electronic file, for example as a print file.

The production data are used to determine a waste-minimizing sequence and arrangement for cutting out the panels 21-23 and, if necessary, further panels for this or other structural elements from at least one raw panel.

The raw panel is fed to a cutting machine, for example a sawing machine, for cutting out the panels. A printer may be installed in the infeed of the cutting machine and prints the pictograms 30 onto the raw panel so that they appear correctly on the panels 21-23 to be cut out. Then, the panels 21-23 are cut out of the raw panel or raw panels and output by the sawing machine.

Instead of automatic printing, one or some of the pictograms 30 could be manually affixed to the cut-out panels 21-23. A printer for stickers with the pictograms 30 can be provided at the outlet of the sawing machine. During the removal of panels 21-23, production personnel can attach the stickers with the pictograms 30 to the panels 21-23. Preferably, the stickers are provided by a production control system using the sticker printer each time a corresponding panel 21-23 is output from the sawing machine.

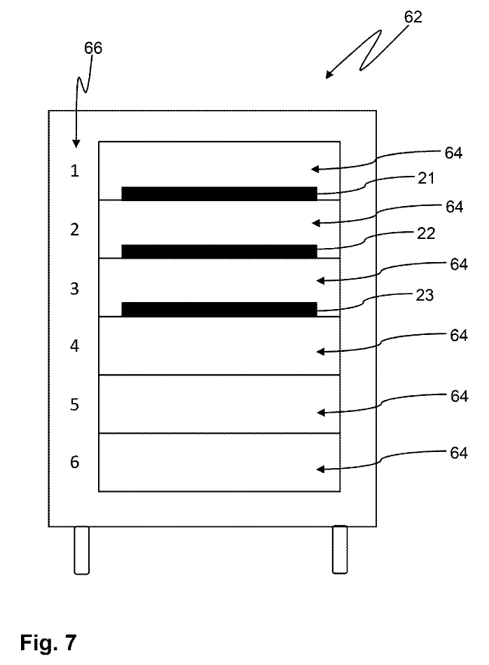

The panels 21-23 can then be sorted in a transport apparatus 62, for example a panel trolley with a plurality of compartments 64 for one panel each, compare also FIG. 7, where it is sketched that the panels 21-23 rest on the floors of the corresponding compartments 64. It is understood that the transport apparatus 62 could also have compartments arranged side by side for a standing arrangement of the panels 21-23.

Preferably, a separate transport apparatus 62 is provided for each panel layer 41-43, 51, 52 of a corresponding structural element 10. This simplifies the transport of the panels to the corresponding structural element and the assignment to the corresponding panel layer. At the same time, a plurality of transport apparatuses 62 can be loaded for different structural elements and/or panel layers, since the panels are provided by the sawing machine in the cutting-waste-optimized sequence.

The pictograms 30 enable, on the one hand, the assignment to the correct transport apparatus 62. For this purpose, a number of the structural element and/or of a construction project as well as information about the panel layer can be noted correspondingly on a docket at the transport apparatus 62.

The compartments 64 of the transport apparatus 62 are each provided with a numbering 66. The panels 21-23 are each placed in the compartment 64 of which the numbering 66 corresponds to the numbering 58 for placing the panels 21-23. For example, the panel 23 could first be placed in the third compartment 64 of the transport apparatus 62. Then, one panel might need to be sorted into a different transport apparatus. The panel 21 could then be inserted into the first compartment 64 of the transport apparatus 62, and so on, until the transport apparatus 62 is equipped with all panels 21-23 for the relevant panel layer 42.

Then the panels 21-23 (and possibly panels for the further panel layers) are moved to the supporting structure 12, which has been prepared according to the production data, using the transport apparatus 62. There, the panels are placed one after the other at the corresponding positions in their corresponding panel layers on the supporting structure 12. The placement usually takes place with the supporting structure 12 in a horizontal orientation and can be carried out by production personnel. The pictograms illustrate to the production personnel the correct positioning and orientation of the panels. Furthermore, an expedient sequence can be specified.

Each of the placed panels 21-23 can initially be provisionally attached to the supporting structure 12 by the production personnel. In some cases, the provisional attaching can also be omitted. Once all panels 21-23 of a corresponding panel layer 42 have been placed, they can be fastened, preferably by machine. It is also conceivable to first only attach the panels of a plurality of panel layers together and then fasten them together.

Once all the panels have been fastened to one side of the supporting structure 12, the supporting structure 12 can be turned over and clad on the other side, if desired. If required, a filling, such as insulation material, can be inserted before the second side is clad.

Once all the panels are fastened, the structural element 10 is complete. The structural element can then be installed in a building.

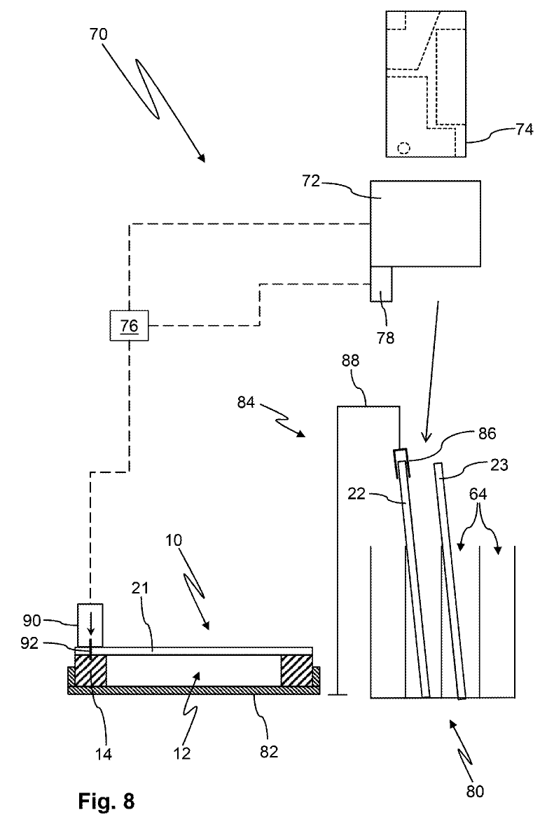

FIG. 8 shows a machine system 70. The machine system 70 has a cutting machine 72, which serves to cut out individual panels 21-23 from raw panels 74. The outlines of the panels 21-23 are indicated by dashed lines. For this purpose, the cutting machine 72 is controlled by a control device 76. The control device 76 and/or the cutting machine 72 can use production data to calculate a cutting-waste-optimized arrangement of the panels 21-23 on the raw panel 74.

The control device 76 is set up to generate a pictogram 30, compare FIGS. 3-5, from the production data for each of the panels 21-23. Here, an output device 78 for the pictograms 30 is arranged at an outlet of the cutting machine 72. The output device 78 can, for example, print the pictograms 30 onto the panels or laser them into their surface.

The panels 21-23 can be provided in a provisioning apparatus 80, preferably in numbered compartments 64, on a support apparatus 82 for a supporting structure 12. The provisioning apparatus can, for example, be a transport apparatus 62 or can be arranged stationary at the support apparatus 82.

For placing the panels 21-23, the supporting structure 12 is arranged on the support apparatus 80. The support apparatus 80 can have structures which fix the supporting structure 12, in particular, its beams 14, in a defined position.

To facilitate a substantially manual placement of the panels 21-23, a placement aid apparatus 84 is provided. The placement aid apparatus 84 can be a holding device 86, for example, a panel gripper. The holding device 86 can be attached to an assistance device 88 to bear the weight of the panels 21-23. The assistance device 88 can, for example, be designed in the form of a crane and/or with a spring-supported support arm. The placement aid 84 reduces the physical strain on production personnel, who are primarily responsible for the positioning of the panels 21-23 on the supporting structure 12, which is simplified by means of the pictograms 30.

A fastening apparatus 90 is used to fasten the correspondingly placed panels 21-23 and is designed to introduce fasteners 92, for example nails, staples and/or screws, to connect the panels 21-23 to the supporting structure 12. Preferably, the fastening apparatus 90 is controlled by the control device 76 for automatic fastening at predetermined locations on the panels 21-23. For the sake of clarity, an automatic device for moving the fastening apparatus 90, for example a gantry or a six-axis robot, is not shown in detail. Alternatively, the fastening apparatus 90 can be operated manually.

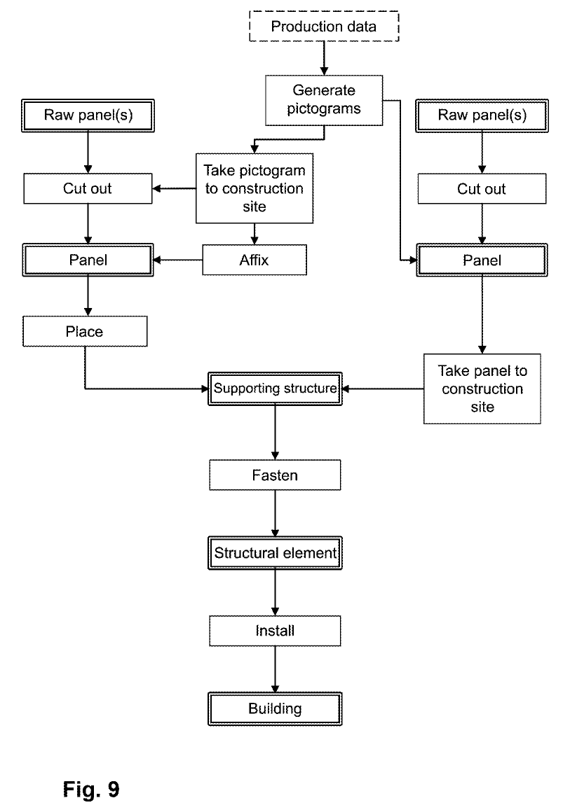

FIG. 9 shows a flowchart of another method for the production of a structural element 10 using panels 21-23 with previously explained pictograms 30.

In this method, pictograms are generated based on production data and provided, for example, in the form of stickers.

In the method variant shown on the left in FIG. 9, at least one of the pictograms is taken to a construction site and serves there as a production order for the manufacture of a panel 21-23. The panel 21-23 manufactured on the construction site will be provided with the pictogram 30.

In the strand of another method variant shown on the right in FIG. 9, at least one panel 21-23 is manufactured in a production facility and provided with a pictogram 30. The panel 21-23 with the pictogram is then taken to the construction site.

A supporting structure 12 is present at the construction site. For example, it is conceivable that one or more of the panels 21-23 of a structural element 10 were damaged during the unloading. The panels 21-23 manufactured on site or the panels 21-23 brought to the construction site are fastened to the supporting structure 12, for example after the damaged panels have been removed. The structural element 10 (re-)constructed in this way can then be installed in a building.

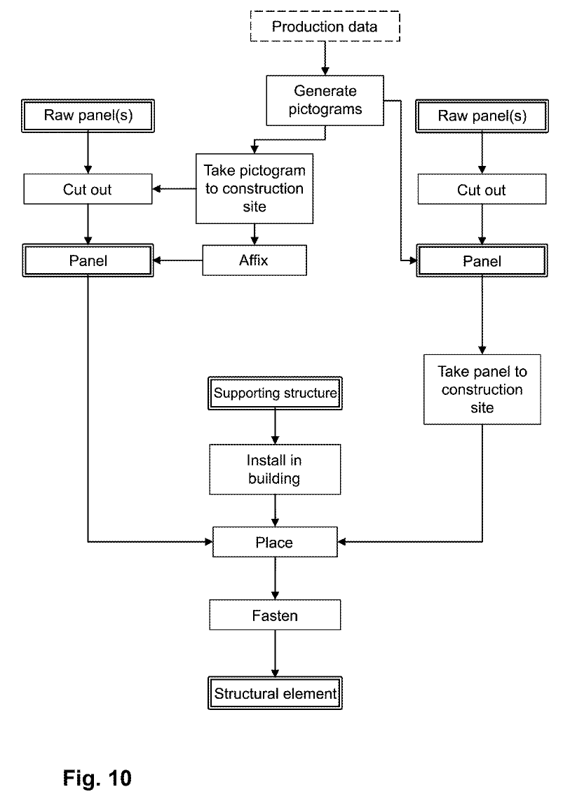

FIG. 10 shows a modification of the method of FIG. 9. Here, the supporting structure 12, to which one or more panels 21-23 may already be fastened, is already installed in a building. Then one or more panels 21-23, manufactured on the construction site or brought to the construction site, are placed on the supporting structure 12 and fastened to the supporting structure 12.

It is conceivable to fasten all panels 21-23 of the structural element 10 to the supporting structure 12 after the supporting structure 10 has been installed in the building. Alternatively, some or more panels 21-23 can be fastened to the supporting structure 12, which is already clad with some panels, as replacements for damaged panels or, for example, as an additional panel layer.

In summary, the invention relates to a pictogram to assist the cladding of structural elements, in particular, for buildings. The pictogram is placed on a panel, which is to be attached to a supporting structure of the structural element along with other panels. The pictogram illustrates the arrangement of the panel on the structural element and preferably relative to the other panels.

### LIST OF REFERENCE SIGNS

Structural element 10
Supporting structure 12
Depiction 12' of the supporting structure
Beam 14
Panel 21, 22, 23
Sketch 21', 22', 23' of the panel
Outline 21'', 22'', 23'' of the panel
Pictogram 30
Part number 32
Number 34 of the structural element
Number 36 of a construction project
Material identifier 38
Inner panel layers 41, 42, 43
Outer panel layers 51, 52
Top view 54
Cross-sectional view 56
Numbering 58 of the placement sequence
Hatching pattern 60
Transport apparatus 62
Compartment 64
Numbering 66 of the compartments 64
Machine system 70
Cutting machine 72
Raw panel 74
Control device 76
Output device 78
Provisioning apparatus 80
Support apparatus 82
Placement aid apparatus 84
Holding device 86
Assistance device 88
Fastening apparatus 90
Fastener 92

What is claimed is:

1. A method for producing a structural element by cladding a supporting structure with a plurality of panels, comprises the steps of:
providing the supporting structure;
providing the plurality of panels, wherein each panel of the plurality of panels bears a pictogram which represents their corresponding position on the structural element;
placing the plurality of panels on the supporting structure at the position shown in the pictogram in each case;
fastening the plurality of panels to the supporting structure.

2. The method according to claim 1, wherein the pictogram of at least one of the panels represents, in addition to the highlighted position of this panel, also positions of other panels.

3. The method according to claim 1, wherein the pictograms of the panels contain a numbering corresponding to a sequence when placing them on the supporting structure, wherein the panels are provided in a transport apparatus or a panel trolley, wherein the transport apparatus has a plurality of numbered compartments, and wherein the panels are arranged in the compartment corresponding to their numbering.

4. The method according to claim 3, wherein the panels are cut out from at least one raw panel, and the sequence when placing them on the supporting structure differs from a sequence when cutting them out and from a sequence when sorting them into the transport apparatus.

5. The method according to claim 1, wherein the pictogram of at least one of the panels represents the structural element in a top view, and/or wherein the pictogram of at least one of the panels represents the shape of the panel and/or the shapes of other panels.

6. The method according to claim 1, wherein the pictograms are each attached at similar locations on the panels.

7. The method according to claim 1, wherein the pictogram of at least one of the panels contains a part number of the panel; and/or wherein the pictogram of at least one of the panels contains information about a destination, about the structural element and/or about a construction project; and/or wherein the pictogram of at least one of the panels contains information about the panel layer of a plurality of overlapping panels in which the panel is to be arranged on the structural element.

8. The method according to claim 1, wherein the pictogram of at least one of the panels represents the structural element in a side view or in a cross-sectional view through the panel.

9. The method according to claim 1, wherein the pictogram of at least one of the panels is affixed to the panel, and/or wherein the pictogram of at least one of the panels is printed onto the panel.

10. The method according to claim 1, wherein the pictogram of at least one of the panels is applied in a cutting machine which cuts out the panel from a raw panel.

11. The pictogram for the panel of the structural element for use in the method according to claim 1, wherein the pictogram represents the position of the panel on the structural element.

12. The panel with the pictogram according to claim 11.

13. The structural element comprising a supporting structure which is clad with panels, wherein at least one of the panels bears the pictogram of claim 11 which represents the position of the panel on the structural element.

14. The method of claim 1, wherein the plurality of panels are wood-based panels.

15. A machine system for producing a structural element by cladding a supporting structure with a plurality of panels, comprising
a support apparatus for a supporting structure;
a control device for generating pictograms, wherein the control device is configured to generate the pictograms where each pictogram represents a position of a panel on a supporting structure;
an output device for outputting the pictograms; and
a fastening apparatus for fastening the panels to the supporting structure.

16. The machine system according to claim 15, wherein the plurality of panels are wood-based panels.

17. The machine system according to claim 15, wherein the machine system further comprises:
a provisioning apparatus for the panels with the applied pictograms; and/or
a placement aid apparatus for holding the panels during manual placement and/or for assisting the manual placement of the panels at the position shown in the pictograms on the supporting structure; and/or
a cutting machine configured for cutting the panels from at least one raw panel.

18. The machine system according to claim 17, wherein the cutting machine is a sawing machine and/or a nesting machine.

19. The machine system according to claim 15, wherein the output device is configured to apply the pictograms to the panels.

20. The panel of claim 12, wherein the panel is a wood-based panel.
